(19) United States
(12) Patent Application Publication
(10) Pub. No.: US 2007/0031786 A1
(43) Pub. Date: Feb. 8, 2007

(54) Dental handpiece

(76) Inventor: Donald J. Heil, Lake Villa, IL (US)

Correspondence Address: DENTSPLY INTERNATIONAL INC, 570 WEST COLLEGE AVENUE, YORK, PA, 17404, US

(21) Appl. No.: 11/401,811

(22) Filed: Apr. 11, 2006

Related U.S. Application Data
(63) Continuation-in-part of application No. 10/369,974, filed on Feb. 18, 2003, now abandoned.
(60) Provisional application No. 60/359,501, filed on Feb. 25, 2002.

(51) Int. Cl. A61C 1/14

(52) U.S. Cl. 433/129; 433/127

(57) ABSTRACT

A dental handpiece component (10) has a bur-tube (20) and a ball bearing assembly (13, 14) supporting the bur-tube (20). The handpiece (10) also has a pusher (32), wedge (30) and chuck jaws (22). Any or all of the handpiece components in metal-to-metal contact (such as, 15, 13, 14, 15, 22, 30, and 32) may be coated with an anti-friction and/or anti-corrosion coating.

### RELATED APPLICATIONS

This application is a Continuation-In-Part of pending U.S. patent application Ser. No. 10/369,974 filed on Feb. 18, 2004, which is a non-provisional patent application claiming priority to U.S. Provisional Pat. App. Ser. No. 60/359,501 now expired.

### TECHNICAL FIELD

The present invention is directed toward dental handpieces. More particularly, the invention is directed toward a dental handpiece having improved metal-to-metal contacts. The handpiece has metal-to-metal contacts that are improved with an anti-friction and/or anti-corrosion coating.

### BACKGROUND OF THE INVENTION

Dental handpieces of the air-driven type are known to have an outer housing which often includes a neck portion. Within the chamber of the housing is a bur-tube adapted to be driven by air supplied through the handle and neck. The housing often includes upper and lower openings that are axially aligned with a bur-tube being supported for rotation by upper and lower bearing assemblies. The upper opening is often closed by a cap or other closure or chucking means. The bur tube normally extends substantially between the openings and has a central bore axially aligned with those openings. The lower end of the bur-tube often contains a pilot which passively guides and supports dental burs or other tools. Such a dental handpiece is disclosed for example, in U.S. Pat. No. 4,089,115 which is hereby incorporated by reference for such disclosure.

The chucks commonly used in high speed dental handpieces for releasably holding dental burs in place have chucking actions that can be generally categorized as falling within one of two groups. The first group includes wrench-operated chucks in which wrenches are utilized either to exert pushing or pulling forces to tighten such chucks. The second group includes spring grip chucks in which the bur-retaining force is generated by the spring action of the chuck and in which a wrench or some other means is utilized to open the jaws when bur removal or insertion is desired. For example, German Patent DE 34 02 635 discloses a dental handpiece having a chuck with spring jaws that exert a gripping force on a dental bur. The jaws may be shifted into bur-releasing positions by depression of a push button at the upper end of the handpiece head. When the button is depressed, a wedge element is urged between the jaws to spread them apart and release the bur. It is also conventional to exert the shifting force by a lever rather than a button.

It has been found that in dental handpieces, the chuck must securely hold a dental instrument, such as a bur or other cutting tool, with high accuracy (for example, within 0.0001 inches) while rotating at very high speeds (from 200,000 to 450,000 rpm or higher). Preferably, the chuck must be easy to open and close without tools to remove and install burs. The chuck must perform this function after repeated cycles of use and sterilization. It is also important that the chuck continue to grip the dental tool even when it is not fully seated into the handpiece.

As stated above, in a conventional handpiece design, a user presses a button or lever, which transmits force through a pusher to a wedge in the chuck assembly. A tapered portion on the wedge enters into a tapered slot in the chuck and spreads the jaws as the push button is depressed, allowing insertion of the dental tool or bur, into the chuck. When the button is released, the jaws close, clamping the bur and pushing the wedge upward. Such a handpiece is commercially available for example, as the TRADITION-PB and the XGT handpieces from DENTSPLY International Inc.

The contact between the wedge and the jaw slot is a sliding contact between two similar metals and is therefore, subject to high friction. Friction can increase as either part wears or corrodes. Also, friction increases the required force on the button or lever to actuate the device, which is uncomfortable to the user, and potentially dangerous by increasing the likelihood of slipping or the like. The wedge may even become stuck in the chuck jaws, rendering the chuck useless.

A need exists therefore, for an improved handpiece that has increased resistance to friction, wear and/or corrosion.

### SUMMARY OF THE INVENTION

It is therefore, an object of the invention to provide a dental handpiece.

It is another object of the invention to provide a dental handpiece improved with respect to its metal-to-metal contacts.

These and other objects of the invention that will become apparent from the following discussion, are accomplished by the invention as hereinafter described and claimed.

In general, a dental handpiece of the type having chucking mechanism to releasably hold a dental tool, the chuck mechanism having as components, a pusher, a wedge and a set of jaws, wherein the improvement comprises coating at least one of the chuck mechanism components with an anti-friction coating.

### BRIEF DESCRIPTION OF THE DRAWING

FIG. 1 is a side elevational view of a cartridge (set) which is normally located within the working head portion of a dental handpiece, having a chuck mechanism according to the present invention.

### PREFERRED EMBODIMENTS FOR CARRYING OUT THE INVENTION

The present invention has application to any dental handpiece where it is advantageous to provide for increased anti-friction and anti-corrosion properties. Such properties are especially advantageous in dental handpieces that are subjected to repeated use and sterilization under harsh conditions of high heat and moisture. The present invention may therefore, find application in any handpiece driven by electric motor, pressurized air or the like.

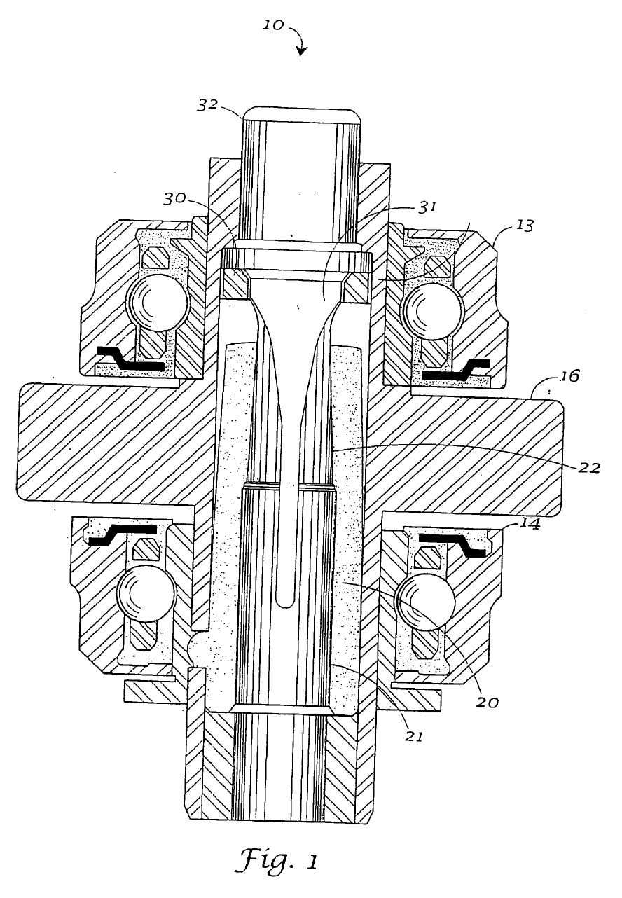

The handpiece selected for illustration is an air-driven handpiece 10 having a pair of ball bearing assemblies 13 and 14 supporting bur-tube 20 for rotation. The bur-tube 20 includes any conventional driving means such as for example, an air-turbine 16 for rotatably driving bur-tube 20. The turbine depicted in FIG. 1 is a radial-flow turbine that is driven by air, but of course, can be of any conventional design.

Handpiece 10 is provided with a chuck 20 having a first open end 21 which can receive a dental tool (not shown) in a conventional manner. Chuck 20 has internally tapered jaws 22 that are employed to hold the dental tool in use. A wedge 30 having a tapered surface 31 is provided and is movable to enter the jaws 22 to spread them in order to receive or remove the tool. A pusher 32 is provided such that a user actuates the pusher 32 to cause a force to be exerted upon the wedge 30 to cause it to enter the jaws 22, again, all in a conventional manner. In the handpiece 10 depicted in the drawings, pusher 32 is a button, but may be any conventional design such as a lever or the like.

According to the invention, at least one metal component of the dental handpiece that is in sliding, physical contact with another metal component is coated with an anti-friction and/or anti-corrosion coating. For example, the wedge 30, pusher 32, bearings 13, 14, bur-tube 20, jaws 22, or any of the other handpiece components, may be so coated within the aspect of the present invention. The anti-friction coating will reduce the friction that exists between the physically contacting parts, thereby making use of the handpiece 10 easier for the user. An anti-corrosion coating will provide for a longer useful life of the handpiece 10 with reduced affects from use and sterilization-induced corrosion.

Preferably, the coating employed provides bot anti-friction and anti-corrosion properties, but it is within the scope of the invention to provide one coating that provides one, or two coatings with each providing a respective one of the desired properties. Further, one contacting component may be coated with one coating while another is coated with another. One or more components may be coated with a coating that provides for both improved properties; all such combinations and other similar ones are within the scope of the invention. By the language “anti-friction and/or anti-corrosion” it is understood to mean separate such coatings or one coating with both properties, interchangeably unless otherwise stated.

The coatings that may be applied are any conventional coatings known in the metal anti-friction and/or anti-corrosion art, which are preferably resistant to degradation in high moisture and high temperature environments.

Preferred coatings include for example, graphite and chromium-nitrate. One preferred graphite coating is Graphit-iC commercially available from IonBond Inc. of Madison Heights, Mich. Such coatings may be applied by any conventional process, such as physical vapor deposition. Graphit-iC is known to form a diamond like carbon (DLC) coating with properties that include low friction and excellent corrosion resistance due to its amorphous structure. It has the capability of retaining its properties in high moisture applications due to the absence of hydrogen in the film.

It should be apparent therefore, that the present invention provides an advantage and an improvement over known dental handpieces. While in the foregoing, embodiments of the invention have been disclosed in considerable detail for purposes of illustration, it will be understood by those skilled in the art that many of these details may be varied without departing from the spirit and scope of the invention.

What is claimed is:

1. A dental handpiece of the type having chucking mechanism to releasably hold a dental tool, the chuck mechanism having as components, a pusher, a wedge and a set of jaws, wherein the improvement comprises coating at least one of the chuck mechanism components with a coating that provides both anti-friction and anti-corrosion properties in the presence of moisture; wherein said coating contains an amorphous component selected from the group consisting of graphite, chromium-nitrate and mixtures thereof.
